(19) United States
(12) Patent Application Publication
(10) Pub. No.: US 2004/0142848 A1
(43) Pub. Date: Jul. 22, 2004

(54) Detergent compositions for cleaning

(76) Inventors: Andrea Zanardi, Bergamo (IT); Italo Accardi, Bergamo (IT)

Correspondence Address: BIRCH STEWART KOLASCH & BIRCH, PO BOX 747, FALLS CHURCH, VA, 22040-0747, US

(21) Appl. No.: 10/735,827

(22) Filed: Dec. 16, 2003

(30) Foreign Application Priority Data
Dec. 18, 2002 (IT) MI2002A002673

(51) Int. Cl. C11D 3/37

(52) U.S. Cl. 510/475

(57) ABSTRACT

Disclosed are detergent formulations in the form of an emulsion containing as stabilising agent between 0.01% and 10% of at least one copolymer obtained by copolymerisation of:

a) 98% to 80% of one or more carboxylic acids containing a double olefin bond;

b) 2% to 20% of one or more vinyl esters of an acid having the formula:

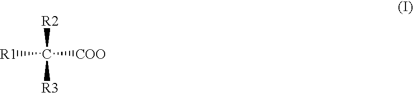

wherein R1, R2 and R3, which are equal or different, are linear or branched alkyl groups, with the proviso that the sum of the carbon atoms of the acid, including the carboxyl group, is between 5 and 10;

c) 0% to 3% of one or more polyallyl ethers of polyfunctional alcohols, calculated on the sum of a)+b).

This invention relates to cleaning formulations based on water and water-immiscible organic substances which contain acrylic acids copolymers and vinyl esters as emulsifying agents.

### BACKGROUND

Formulations designed for cleaning various surfaces (such as furniture and floors) and clothes contain numerous components with different chemicophysical properties. These formulations often contain raw materials which are miscible with one another with difficulty, or tend to separate.

It is common practice to use surfactants to homogenise multiphase systems (water-in-oil or oil-in-water emulsions) or to solubilise substances which are not miscible with one another.

Non-ionic surfactants, anionic, cationic or amphoteric surfactants or mixtures thereof are used for this purpose. Examples of non-ionic surfactants are alkylphenols, preferably octyl or nonylphenols ethoxylated with 1 to 25 moles of ethylene oxide, C₆-C₂₂ linear- or branched fatty alcohols ethoxylated, propoxylated or etho-propoxylated with 1 to 40 moles of ethylene oxide, propylene oxide or mixtures thereof, C₆-C₂₂ linear- or branched fatty acids and their amides, ethoxylated with 1 to 40 moles of ethylene oxide, propylene oxide or mixtures thereof, and C₆-C₂₂ linear- or branched fatty amines ethoxylated, propoxylated or etho-propoxylated with 1 to 40 moles of ethylene oxide, propylene oxide or mixtures thereof.

Non-ionic surfactants with an HLB (Hydrophile-Lipophile Balance) value lower than 8 are classified as water-in-oil emulsifiers. Surfactants with an HLB value of between 8 and 14 are classified as detergents and wetting agents. Surfactants with an HLB<14 are classified as oil-in-water emulsifiers and solubilising agents.

Examples of anionic surfactants are alkyl or alkenyl sulphates with the formula R—O—SO₃⁻M⁺, wherein R may have 10 to 22 carbon atoms and M is a cation of alkaline metal, ammonium or alkanolammonium, alkyl or alkenyl sulphates with the formula R—O—(CH₂—CH₂)ₙ—SO₃⁻M⁺, wherein R may have 10 to 22 carbon atoms, M is a cation of alkaline metal, ammonium or alkanolammonium, and n may have a value between 1 and 25, ethoxylated and sulphated alkylphenols, alkylpolysaccharide and alkylpolyglucoside sulphates, alkylbenzene sulphonates, primary or secondary C₆-C₂₄ alkane sulphonates, C₆-C₂₄ olefin sulphonates, sulphosuccinates and alkylsulphosuccinates, amides of fatty acids with taurine and methyl-taurine wherein the sulphonic groups are generally salified with cations of alkaline metals, ammonium or alkanolammonium, soaps, with the carboxyl group in either the primary or the secondary position, alkyl ethoxy or (poly)ethoxy carboxylates with the general formula RO(CH₂CH₂O)xCH₂COOM, wherein M is the cation of alkaline metals, ammonium or alkanolammonium, sarcosinates with the general formula R—CON(R₁)CH₂—COOM, wherein M is the cation of alkaline metals, ammonium or alkanolammonium, and amphoteric surfactants.

These surfactants are generally used in quantities of not less than 0.3% (w/w) and not more than 5% (w/w) of the weight of the total formulation when used as a stabiliser, and in larger quantities when they are also used as a detergent, such as in washing machine detergent formulations.

### DESCRIPTION OF THE INVENTION

It has now been found that copolymers of carboxylic acids containing an olefinic bond, with vinyl esters of aliphatic acids can wholly or partly replace the conventional surfactants mentioned above, with the advantage that the formulation is more stable over time.

The polymers which can be used according to the invention are preferably copolymers of acrylic or methacrylic acid with vinyl esters of branched aliphatic acids having the formula:

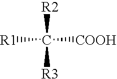

wherein R1, R2 and R3, which are equal or different, represent linear or branched alkyl groups, with the proviso that the sum of the total carbon atoms, including carboxyl, is between 5 and 10, said copolymers being optionally cross-linked with allyl ethers of polyvalent alcohols such as pentaerythritol triallyl ether.

The polymers described above are known, for example, from IT 1,200,111 and EP 724,875, and are used in the form of their alkaline metal, ammonium or amine salts.

These polymers mainly perform their activity in cases in which formulations based on water and water-immiscible organic solvents need to be stabilised, and also in cases where mixtures of polar organic solvents such as methanol, ethanol and dimethylformamide need to be stabilised with other solvents immiscible with them.

A characteristic of these copolymers is that not only they give the formulation containing them high viscosity, but also maintain said viscosity in the presence of high quantities of electrolytes such as sodium chloride, sodium sulphate, ammonium sulphate, ammonium phosphate, colorants and anionic surfactants. For this reason these copolymers are used in all products containing a high electrolyte concentration.

### DETAILED DESCRIPTION OF THE INVENTION

For the purposes of the present invention, the preferred copolymer consists of:

a) 98% to 80% of one or more carboxylic acids containing a double olefinic bond;

b) 2% to 20% of one or more vinyl esters of trialkylacetic acids having the formula:

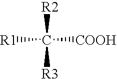

wherein R1, R2 and R3, which are equal or different, represent linear or branched alkyl groups, with the proviso that the sum of the total carbon atoms, including the carboxyl, is between 5 and 10;

c) optionally between 0% and 3% of one or more cross-linking agents constituted by allyl ethers of polyvalent alcohols, calculated on the sum of the monomers referred to in paragraphs a) and b).

The copolymer in which component a) is acrylic acid, component b) is isodecanoic acid vinyl ester and component c) is pentaerythritol triallyl ether is particularly preferred for the purposes of this invention.

According to the invention, the quantity of copolymer used is between 0.01% and 10%, and preferably between 0.1% and 3%, of the total weight of the formulation.

Formulations obtained by using a copolymer according to the invention as stabiliser and/or emulsifier, alone or mixed with surfactants which are commonly employed according to the state of the art, are particularly stable, and may take the form of water-in-oil or oil-in-water emulsions, or a gel.

Examples of said formulations are emulsions containing pine oil, limonene, silicones, liquid paraffin, waxes, designed for cleaning furniture or floor or clothes. Moreover, the copolymers to which this invention relates are particularly suitable to stabilise formulations containing silicone-based antifoaming agents or fragrances, constituents which are difficult to solubilise and have a strong tendency to separate. Anti-foaming agents are present in the formulations according to the invention in percentages of between 0.01 and 40% of the total weight of the formulation.

When present, essential oils or fragrances are used in concentrations of between 0.01 and 50% of the total weight of the formulation.

The quantity of copolymer used in said formulations varies according to the nature and quantity of the elements to be emulsified and it is comprised between 0.01% and 10%.

Before use, the copolymer must be pre-dispersed in one or more of the phases present in the formulation, usually the aqueous phase or the oily phase; after mechanical homogenisation of the phases, the pH is adjusted to the desired value with an alkaline substance such as sodium hydroxide, potassium hydroxide, an alkanolamine, an aliphatic amine, aminoethylpropanol, aminoethyl propanediol, etc.

The examples set out below illustrate some compositions of formulations containing the copolymer and/or a mixture of copolymer and surfactant in a smaller quantity than traditional formulations.

In the examples, the copolymer according to the invention is indicated as COPOLYMER. This copolymer was prepared according to example no. 2/F of IT 1,200,111.

### EXAMPLE 1

Compositions 1, 2 and 3 describe a floor wax in the form of an emulsion containing both synthetic wax and conventional natural wax.

This formulation was prepared with surfactant acting as emulsifier alone (Formula 1), with a mixture of surfactant acting as emulsifier and COPOLYMER (Formula 2), or with the COPOLYMER alone, wholly replacing the surfactant acting as emulsifier (Formula 3).

In the product with surfactant only, separation begins to occur after 2 months at 40° C., whereas the two formulations containing the COPOLYMER show excellent stability over time and increased viscosity. All the viscosities were measured at 20° C. with a Brookfield RV viscosimeter, spindle 2.

Composition 1 - Floor wax (comparison formula)

| | |
|---|---|
| Carnauba wax (natural wax) | 2% |
| Sasolwax A2 (synthetic wax) | 2% |
| Emcol 4100M (surfactant based on disodium | 1.5% |
| myristamide MEA sulphosuccinate, acting as | |
| emulsifier) | |
| Empilan KCL 11 (surfactant based on | 0.3% |
| ethoxylated fatty alcohol 11EO) | |
| Perfume | 0.3% |
| Germaben II (preservative) | 0.2% |
| NaOH (10%) | at pH 7 |
| Demineralised water | q.s. for 100% |

pH: 7
Viscosity (mPa · s): 80

Composition 2 - Floor wax (according to the invention)

| | |
|---|---|
| Carnauba wax (natural wax) | 2% |
| Sasolwax A2 (synthetic wax) | 2% |
| Emcol 4100M (surfactant based on disodium | 0.5% |
| myristamide MEA sulphosuccinate, acting as | |
| emulsifier) | |
| Empilan KCL 11 (surfactant based on | 0.3% |
| ethoxylated fatty alcohol 11EO) | |
| COPOLYMER | 0.5% |
| Perfume | 0.3% |
| Germaben II (preservative) | 0.2% |
| NaOH (10%) | at pH 7 |
| Demineralised water | q.s. for 100% |

pH: 7
Viscosity (mPa · s): 700

Composition 3 - Floor wax (according to the invention)

| | |
|---|---|
| Carnauba wax (natural wax) | 2% |
| Sasolwax A2 (synthetic wax) | 2% |
| COPOLYMER | 1% |
| Empilan KCL 11 (ethoxylated fatty alcohol | 0.3% |
| 11EO) | |
| Perfume | 0.3% |
| Germaben II (preservative) | 0.2% |
| NaOH (10%) | at pH 7 |
| Demineralised water | q.s. for 100% |

| | Composition 1 | Composition 2 | Composition 3 |
|---|---|---|---|
| Initial viscosity | 80 | 700 | 800 |
| (mPa · s) | | | |
| Viscosity after 1 | 80 | 700 | 800 |
| month at 40° C. | | | |
| (mPa · s) | | | |
| Viscosity after 2 | 70 | 750 | 870 |
| months at 40° C. | (slight separation) | | |
| (mPa · s) | | | |
| Viscosity after 3 | 70 | 750 | 900 |
| months at 40° C. | (separation into two | | |
| (mPa · s) | phases) | | |

pH: 7
Viscosity (mPa · s): 700

### EXAMPLE 2

Compositions 4, 5 and 6 below describe a cream for hard surfaces containing a large quantity of d-Limonene. This formulation is traditionally prepared using a surfactant acting as emulsifier (Composition 4). In formula 5, part of the surfactant acting as emulsifier is replaced by the copolymer, while Composition 6 only contains the copolymer as emulsifying agent.

Composition 4 - Cream with d-Limonene (comparison formula)

| | |
|---|---|
| d-Limonene | 8% |
| Amphisol K (surfactant based on potassium cetyl | 1.55% |
| phosphate, acting as emulsifier) | |
| Lutensol (surfactant based on ethoxylated fatty | 2% |
| alcohol 7EO) | |
| Nansa (dodecyl benzenesulphonic acid) | 0.5% |
| Propylene glycol | 3.5% |
| Caustic soda | at pH 7.5 |
| Demineralised water | q.s. for 100 |

Composition 5 - Cream with d-Limonene
(according to the invention)

| | |
|---|---|
| d-Limonene | 8% |
| COPOLYMER | 0.55% |
| Amphisol K (surfactant based on potassium cetyl | 0.5% |
| phosphate, acting as emulsifier) | |
| Lutensol AO7 (surfactant based on ethoxylated | 2% |
| fatty alcohol 7EO) | |
| Nansa (dodecyl benzenesulphonic acid) | 0.5% |
| Propylene glycol | 3.5% |
| Caustic soda | at pH 7.5 |
| Demineralised water | q.s. for 100 |

pH: 7.5
Viscosity (mPa · s): 100

Composition 6 - Cream with d-Limonene
(according to the invention)

| | |
|---|---|
| d-Limonene | 8% |
| COPOLYMER | 0.55% |
| Lutensol AO7 (surfactant based on ethoxylated | 2% |
| fatty alcohol 7EO) | |
| Nansa (dodecyl benzenesulphonic acid) | 0.5% |
| Propylene glycol | 3.5% |
| Caustic soda | at pH 7.5 |
| Demineralised water | q.s. for 100 |

pH: 7.5
Viscosity (mPa · s): 1000

| | Composition 4 | Composition 5 | Composition 6 |
|---|---|---|---|
| Initial viscosity | 100 | 1000 | 1000 |
| (mPa · s) | | | |
| Viscosity after 1 | 100 | 1100 | 1100 |
| month at 40° C. | | | |
| (mPa · s) | | | |
| Viscosity after 2 | 150 | 950 | 1050 |
| months at 40° C. | | | |
| (mPa · s) | | | |
| Viscosity after 3 | 170 | 925 | 1050 |
| months at 40° C. | (separation into | | |
| (mPa · s) | two phases) | | |

pH: 7.5
Viscosity (mPa · s): 1000

### EXAMPLE 3

Compositions 7 and 8 are two washing machine detergent formulations containing a silicone-based anti-foaming agent. Composition 8 shows excellent stability over time, whereas Composition 7 leads to complete separation of the silicone from the rest of the formulation.

Composition 7 - HEAVY-DUTY LIQUID (comparison example)

| | |
|---|---|
| Nansa (dodecyl benzenesulphonic acid) | 8% |
| Empimin KSN 70 LA (lauryl ether sulphate 3EO) | 7% |
| Lutensol AO7 (surfactant based on ethoxylated fatty | 3% |
| alcohol 7EO) | |
| Edenor K12-18 (mixture of fatty acids of | 2% |
| tallow/coconut) | |
| KOH (50%) | 1.2% |
| Bidistilled olein | 1% |
| Anti-foaming agent (silicone-based) | 0.4% |
| Citric acid monohydrate | 2% |
| EDTA (sequestering agent) | 0.06% |
| NaOH (10%) | at pH 9 |
| Demineralised water | q.s. for 100% |

Composition 8 - HEAVY-DUTY LIQUIDS (according to the invention)

| | |
|---|---|
| Nansa (dodecyl benzenesulphonic acid) | 8% |
| Empimin KSN 70 LA (lauryl ether sulphate 3EO) | 7% |
| Lutensol AO7 (surfactant based on ethoxylated fatty | 3% |
| alcohol 7EO) | |
| Edenor K12-18 (mixture of fatty acids of | 2% |
| tallow/coconut) | |
| COPOLYMER | 0.5% |
| KOH (50%) | 1.2% |
| Bidistilled olein | 1% |
| Anti-foaming agent(silicone-based) | 0.4% |
| Citric acid monohydrate | 2% |
| EDTA (sequestering agent) | 0.06% |
| NaOH (10%) | at pH 9 |
| Demineralised water | q.s. for 100% |

pH: 9
Viscosity (mPa · s): 200

pH: 9
Viscosity (mPa · s): 1000

| | Composition 7 | Composition 8 |
|---|---|---|
| Initial viscosity (mPa · s) | 200 | 1000 |
| Viscosity after 1 month | 220 | 1100 |
| at 40° C. (mPa · s) | | |
| Viscosity after 2 months | 180 (separates) | 950 |
| at 40° C. (mPa · s) | | |
| Viscosity after 3 months | 180 (separates) | 950 |
| at 40° C. (mPa · s) | | |

1. Detergent formulations in the form of an emulsion containing, as stabilising agent, 0.01% to 10% of at least one copolymer obtained by copolymerisation of:
a) 98% to 80% of one or more carboxylic acids containing a double olefinic bond;
b) 2% to 20% of one or more vinyl esters of an acid having the formula: 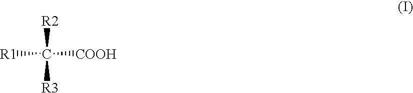
wherein R1, R2 and R3, which are equal or different, are linear or branched alkyl groups, with the proviso that the sum of the carbon atoms of the acid, including the carboxyl group, is between 5 and 10;
c) 0% to 3% of one or more polyallyl ethers of polyfunctional alcohols, calculated on the sum of a)+b):

2. Detergent formulations as claimed in claim 1, wherein:
a) the carboxylic acid containing a double olefin bond is acrylic acid;
b) the vinyl ester is neodecanoic or isodecanoic acid ester;
c) the polyallyl ether of polyfunctional alcohol is pentaerythritol triallyl ether.

3. Detergent formulations, not in emulsion form, as claimed in claims 1 and 2, containing raw materials which are not miscible or only partly miscible with one another.

4. Detergent formulations as claimed in claims 1, 2 and 3, containing silicone-based anti-foaming agents.

5. Detergent formulations as claimed in claim 4, wherein the silicone-based anti-foaming agent is used at a concentration of between 0.01% and 40% of the total weight of the formulation.

6. Detergent formulations as claimed in claims 1, 2 and 3, containing essential oils and fragrances in general.

7. Detergent formulations as claimed in claim 6, wherein the essential oil or fragrance is used at a concentration of between 0.01% and 50% of the total weight of the formulation.
